(19) United States
(12) Patent Application Publication
(10) Pub. No.: US 2010/0061015 A1
(43) Pub. Date: Mar. 11, 2010

(54) MAGNETIC DISK DEVICE AND MAGNETIC HEAD

(75) Inventor: Yoshiaki Tanida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/505,899

(22) Filed: Jul. 20, 2009

(30) Foreign Application Priority Data
Sep. 9, 2008 (JP) 2008-231118

(51) Int. Cl. G11B 5/127

(52) U.S. Cl. 360/125.02; G9B/5.04

(57) ABSTRACT

A magnetic disk device includes: a magnetic disk that includes a magnetic recording layer exhibiting Ising ferromagnetism; a recording magnetic pole that includes a pair of tip magnetic poles that apply a recording magnetic field to an area of the magnetic recording layer; and an auxiliary magnetic pole that includes a pair of tip magnetic poles that apply an auxiliary magnetic field that intersects with the recording magnetic field to the area where the recording magnetic field is applied, wherein the recording magnetic field is applied to the area while the auxiliary magnetic field is applied to the area.

### CROSS-REFERENCE TO RELATED APPLICATION

This application is based upon and claims the benefit of priority of the prior Japanese Patent Application No. 2008-231118, filed on Sep. 9, 2008, the entire contents of which are incorporated herein by reference.

### FIELD

The embodiments discussed herein are directed to a magnetic disk device that records data on a high-coercivity magnetic recording layer by using a weak magnetic field and a magnetic head for use in the magnetic disk device.

### BACKGROUND

With increasing recording density of a magnetic disk, a bit length pertaining to magnetic recording has been reduced. Such a reduction in length increases a demagnetizing field. Hence, a magnetic material having a high coercivity is desirably used in a magnetic recording layer to reduce the bit length to thereby attain high recording density. A high-coercivity magnetic material is also necessary for minute domains so that the minute domains are protected from influences exerted by thermal fluctuation. This circumstance holds true not only with horizontal recording but also with vertical recording.

However, using a high-coercivity magnetic material in a magnetic recording layer of a magnetic disk entails an increase in intensity of a recording magnetic field (magnetic writing field), which undesirably increases heat generation and/or power consumption. Magnetic recording (writing) is desirably performed by using a small recording magnetic field to prevent increase in heat generation and/or power consumption.

Hybrid recording that utilizes laser light has been known as a method of recording data on a high-coercivity magnetic recording layer by using a small recording magnetic field. The hybrid recording is performed by irradiating an area of the magnetic recording layer, to which a recording magnetic field is applied, with laser light to locally heat the magnetic recording layer. The Curie temperature of the area heated by the laser light decreases because the coercivity of the area decreases, so that data can be easily recorded on the area even by using a relatively small recording magnetic field.

A technique that utilizes an Ising ferromagnetic material as the magnetic recording layer has been disclosed in, for example, Japanese Laid-open Patent Publication No. 2001-118379. In this technique, a phase transition temperature is controlled by controlling a fractal dimensionality of a fractal-based structure. Data is recorded on the magnetic recording layer is by utilizing the phase transition.

As described previously, magnetic recording on a high-coercivity magnetic recording layer by using a small recording magnetic field has conventionally been performed by locally heating an area of the magnetic recording layer with laser light to thereby locally decrease the coercivity of the area.

However, the conventional recording method in which the magnetic recording layer is locally heated is disadvantageous in involving cooling of the heated area immediately after data has been recorded. This cooling is desirably performed, for example, before data reading from the magnetic recording layer is started so that the coercivity of the recorded area is sufficiently increased. However, in some environment, e.g., in an aerospace, heat is insufficiently dissipated to surroundings. Because heat dissipation takes much time in such an environment, recording takes a relatively long time, which is a problem.

The other conventional technique that controls a phase transition temperature of an Ising ferromagnetic material by controlling a fractal dimensionality is disadvantageous in involving changing a fractal-based structure. This is because it is not easy to change the phase transition temperature after the fractal-based structure has already been formed. Accordingly, even when an Ising ferromagnetic material having a fractal-based structure is used as a magnetic recording layer, it is difficult to decrease the coercivity of the magnetic recording layer without irradiation of laser light during recording. Hence, it is not easy to perform data recording without heating the magnetic recording layer.

### SUMMARY

According to an aspect of the invention, a magnetic disk device includes: a magnetic disk that includes a magnetic recording layer exhibiting Ising ferromagnetism; a recording magnetic pole that includes a pair of tip magnetic poles that apply a recording magnetic field to an area of the magnetic recording layer; and an auxiliary magnetic pole that includes a pair of tip magnetic poles that apply an auxiliary magnetic field that intersects with the recording magnetic field to the area where the recording magnetic field is applied, wherein the recording magnetic field is applied to the area while the auxiliary magnetic field is applied to the area.

According to another aspect of an embodiment, a magnetic head is for use in recording data on a magnetic recording layer of a magnetic disk. The magnetic head includes: first to fourth yokes that are magnetic thin films, the yokes being laminated with non-magnetic layers interposed therebetween on an upper surface of a substrate; first to fourth tip magnetic poles that are formed on tips of the first to fourth yokes, respectively, and arranged perpendicular to the upper surface of the substrate, the first yoke and the third yoke being magnetically connected together, the second yoke and the fourth yoke being magnetically connected together, the first tip magnetic pole and the third tip magnetic pole defining a recording gap therebetween; a recording coil that magnetizes the first and third yokes to induce a recording magnetic field parallel to the magnetic recording layer in the recording gap; and an auxiliary coil that magnetizes the second fourth yokes to induce an auxiliary magnetic field flowing from the second tip magnetic pole to the fourth tip magnetic pole such that a magnetic flux of the auxiliary magnetic field out of the second tip magnetic pole perpendicularly enters the magnetic recording layer and returns to the second tip magnetic pole through the fourth tip magnetic pole that serves as a return path.

According to another aspect of an embodiment, a magnetic head is for use in recording data on a magnetic recording layer of a magnetic disk. The magnetic head includes: first to fourth yokes that are magnetic thin films, the yokes being laminated with non-magnetic layers interposed therebetween on an upper surface of a substrate; first to fourth tip magnetic poles that are formed on tips of the first to fourth yokes, respectively, and arranged perpendicular to the upper surface of the substrate, the first yoke and the third yoke being magnetically connected together, the second yoke and the fourth yoke being magnetically connected together, the first tip magnetic pole and the third tip magnetic pole defining a recording gap therebetween; an auxiliary coil that magnetizes the first and third yokes to induce an auxiliary magnetic field parallel to the magnetic recording layer in the recording gap; and a recording coil that magnetizes the second and fourth yokes to induce a recording magnetic field flowing from the second tip magnetic pole to the fourth tip magnetic pole such that a magnetic flux of the recording magnetic field out of the second tip magnetic pole perpendicularly enters the magnetic recording layer and returns to the second tip magnetic pole through the fourth tip magnetic pole that serves as a return path.

According to another aspect of an embodiment, a magnetic head is for use in recording data on a magnetic recording layer of a magnetic disk. The magnetic head includes: a pair of yokes that are magnetically connected together, each of the yokes being formed of a magnetic thin film and including a tip magnetic pole on a tip of the yoke, the tip magnetic poles of the yokes being arranged to have a recording gap therebetween; a recording coil that magnetizes the pair of the yokes to induce a recording magnetic field parallel to the magnetic recording layer in the recording gap; a pair of auxiliary yokes that are magnetically connected together, each of the auxiliary yokes being formed of a magnetic thin film and including a tip magnetic pole, the tip magnetic poles of the auxiliary yokes are arranged to sandwich the tip magnetic poles of the yokes therebetween in a width direction of a track; and an auxiliary coil that magnetizes the auxiliary yokes to induce an auxiliary magnetic field parallel to the magnetic recording layer between the tip magnetic poles of the auxiliary magnetic pole.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic perspective view of a magnetic disk device according to a first embodiment of the present invention;

FIG. 2 is a schematic perspective view of a magnetic head depicted in FIG. 1;

FIG. 3 is a schematic perspective view of an auxiliary magnetic pole depicted in FIG. 2;

FIGS. 4A and 4B are schematic diagrams for explaining a recording method according to the first embodiment;

FIGS. 5A and 5B are schematic diagrams for explaining a recording method according to a second embodiment of the present invention;

FIGS. 6A and 6B are schematic cross-sectional views for explaining a recording method according to a third embodiment of the present invention;

FIG. 7 is a schematic perspective view of a magnetic head according to a fourth embodiment of the present invention;

FIG. 8 is a schematic perspective view of an auxiliary magnetic pole depicted in FIG. 7;

FIG. 9 is a schematic perspective view of a magnetic disk device according to a fifth embodiment of the present invention; and

FIG. 10 is a schematic cross-sectional view of the magnetic disk device taken along a line A-B of FIG. 9.

### DESCRIPTION OF EMBODIMENTS

Preferred embodiments of the present invention will be described with reference to accompanying drawings. A first embodiment of the present invention relates to a magnetic disk device 101 that performs longitudinal recording while applying to a magnetic recording layer 24 an auxiliary magnetic field 11 that is perpendicular to the magnetic recording layer 24.

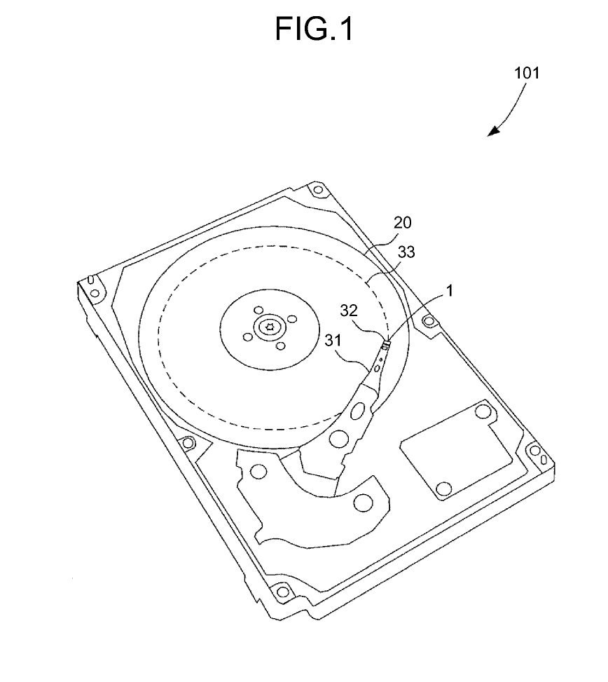

FIG. 1 is a schematic perspective view depicting an overall configuration of the magnetic disk device 101 according to the first embodiment.

As depicted in FIG. 1, the magnetic disk device 101 according to the first embodiment includes a magnetic disk 20, a slider 32, a magnetic head 1 arranged on a tip of the slider 32, and an arm 31 for positioning the magnetic head 1 above a track 33. The magnetic head 1 writes and reads data to and from the magnetic disk 20. The slider 32 floats over a surface of the magnetic disk 20.

The magnetic disk 20 in the magnetic disk device 101 according to the first embodiment uses an Ising ferromagnet, such as UIr (uranium-iridium), as a recording magnetic layer. UIr exhibits magnetic characteristics of an Ising ferromagnet. The Curie temperature Tc of the UIr-based compound is 46 kelvin (K). An Ising ferromagnet is a magnet that is expressed by an Ising model and that exhibits a ferromagnetic phase. When a magnetic field component perpendicular to the easy axis of an Ising ferromagnet is applied to the Ising ferromagnet, the Curie temperature Tc of the Ising ferromagnet decreases according to the intensity of the magnetic field. For example, a direction of the easy axis of UIr is [1 0 −1] while a direction of the magnetic component perpendicular to the easy axis of UIr is [0 1 0] or [1 0 1]. Hence, by applying the auxiliary magnetic field that intersects, e.g., perpendicularly, with a recording magnetic field to an Ising ferromagnet, it is possible to decrease the Curie temperature of the Ising ferromagnet to thereby perform data recording by using a relatively weak recording magnetic field.

The structure of the arm 31 is similar to that of an arm of a typical magnetic disk device. More specifically, the arm 31 includes, at its tip, the slider 32 that floats over the surface of the magnetic disk 20, and positions the magnetic head 1, which is provided on the tip of the slider 32, above an arbitrary track 33.

The magnetic head 1 according to the first embodiment includes a recording head that differs from that of a magnetic head of a conventional magnetic disk device. The magnetic head 1 is the same with the conventional magnetic head in other components such as a reading head for use in reading. For clarity of description, components serving as the recording head of the magnetic head 1 will be described in detail below.

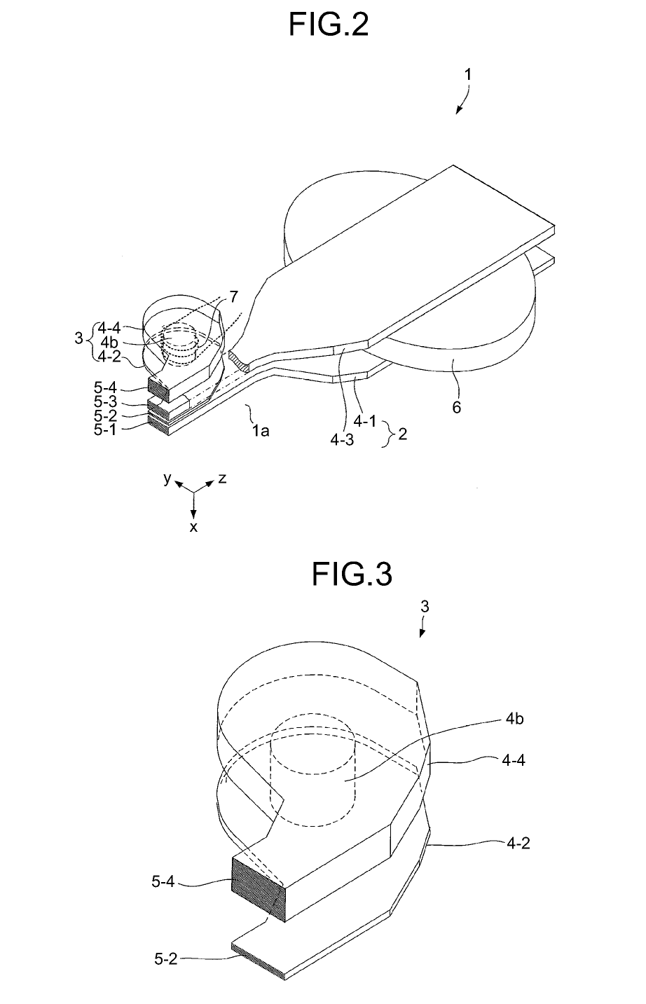

FIG. 2 is a schematic perspective view of the magnetic head 1 according to the first embodiment, depicting a main structure of the magnetic head 1 for use in horizontal recording. FIG. 3 is a schematic perspective view of an auxiliary magnetic pole 3 according to the first embodiment, depicting the structure of the auxiliary magnetic pole 3. A recording magnetic pole 2 and the auxiliary magnetic pole 3 form the magnetic head 1. Axes are given in the accompanying drawings such that, referring to FIG. 2, the axis orthogonal to a recording surface of the magnetic disk 20 is z-axis, the axis extending in the width direction of the track 33 is y-axis, and the axis extending along the spinning direction (i.e., along a tangential direction of the track 33) of the magnetic disk 20 is x-axis.

Referring to FIGS. 2 and 3, the magnetic head 1 according to the first embodiment includes a thin film head formed on a substrate 1a of the magnetic head 1. The magnetic head 1 is fixed to the tip of the slider 32 such that the upper surface of the substrate 1a is parallel to the y-z plane, i.e., perpendicular to the spinning direction of the magnetic disk 20.

The magnetic head 1 includes a first yoke 4-1, a second yoke 4-2, a third yoke 4-3, and a fourth yoke 4-4, which are laminated from lowest to highest in this order on the substrate 1a. The first to fourth yokes 4-1 to 4-4 are laminated with non-magnetic films interposed therebetween, the first to fourth yokes 4-1 to 4-4 are magnetically separated from one another by the non-magnetic thin films. The first yoke 4-1 is magnetically connected with the third yoke 4-3 via a connector 4a, and the second yoke 4-2 is magnetically connected with the fourth yoke 4-4 via a connector 4b. The connectors 4a and 4b will be described later.

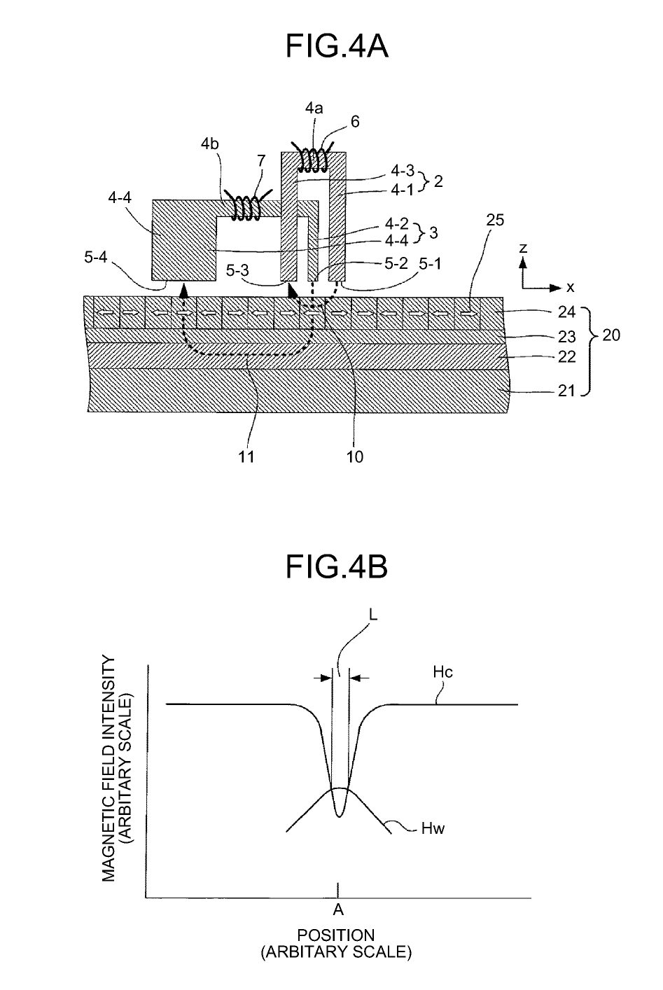

Each of the first and third yokes 4-1 and 4-3 is similar in planar shape with a yoke of a conventional recording head for use in horizontal recording. More specifically, each of the first and third yokes 4-1 and 4-3 is small in width at a tip portion where the yoke faces the surface (x-y plane) of the magnetic disk 20. The width increases at a basal end portion where each of the first and third yokes 4-1 and 4-3 extends vertically upward relative to the surface of the magnetic disk 20. The connector 4a (see FIG. 4A) formed of a magnetic material is arranged near the basal end portion of each of the first yoke 4-1 and the third yoke 4-3 to magnetically connect them together. A recording coil 6 wounded around the connector 4a is provided. The first yoke 4-1 and the third yoke 4-3 are magnetized in response to a signal current that flows through the recording coil 6.

The tip of the first yoke 4-1 has a first tip magnetic pole 5-1, and the tip of the third yoke 4-3 has a third tip magnetic pole 5-3. Each of the first and third tip magnetic poles 5-1 and 5-3 is a flat surface that faces the magnetic disk 20. The first and third tip magnetic poles 5-1 and 5-3 are separated from each other with a clearance therebetween formed by the second yoke 4-2 and the non-magnetic layers that are formed on the upper and lower surfaces of the second yoke 4-2. The clearance, that is a recording gap, extends along the x-axis. A recording magnetic field, which will be descried later, that is parallel to the spinning direction (along the x-axis) of the magnetic disk 20 is induced in the recording gap.

The second yoke 4-2 is situated such that its tip portion is interposed between the first and third yokes 4-1 and 4-3 and its basal end portion extends to outside of the first and third yokes 4-1 and 4-3 in planar shape. The second yoke 4-2 has a tip portion that is as narrow as, e.g., the track width, and a wide basal end portion in planar shape.

The fourth yoke 4-4 has the tip portion that is equal to or broader than the track width. The fourth yoke 4-4 has a similar planar shape with that of the second yoke 4-2. The fourth yoke 4-4 is preferably thicker than the second yoke 4-2. When the fourth yoke 4-4 is constructed in this manner, the magnetic flux density of the fourth yoke 4-4 serving as a return path from the second yoke 4-2 is decreased, thereby preventing faulty magnetic overwrite by way of the return path.

The second yoke 4-2 has, at its tip end, a second tip magnetic pole 5-2, and the fourth yoke 4-4 has, at its tip, a fourth tip magnetic pole 5-4. The second and fourth tip magnetic poles 5-2 and 5-4 are flat surfaces that face the magnetic disk 20. The second tip magnetic pole 5-2 on the tip of the second yoke 4-2 is arranged such that the second tip magnetic pole 5-2 is inserted into the clearance (i.e., the recording gap) between the first and third tip magnetic poles 5-1 and 5-3 on the tips of the first and third yokes 4-1 and 4-3. The fourth tip magnetic pole 5-4 on the tip of the fourth yoke 4-4 is arranged away from the first to third tip magnetic poles 5-1 to 5-3 in the direction of negative x-axis. The first to fourth tip magnetic poles 5-1 to 5-4 are aligned on the x-y plane along the x-axis. The second tip magnetic pole 5-2 generates the auxiliary magnetic field that is perpendicular to the upper surface of the magnetic disk 20, as described later. The fourth tip magnetic pole 5-4 forms the return path of the auxiliary magnetic field. The second tip magnetic pole 5-2 and the fourth tip magnetic pole 5-4 define an auxiliary gap, in which the auxiliary magnetic field perpendicular to the upper surface of the magnetic disk 20 is induced.

The connector 4a formed of the magnetic material is arranged on the basal ends of the second and fourth yokes 4-2 and 4-4 to magnetically connect them together. An auxiliary coil 7 wound around the connector 4a excites. When an electric current that flows through the auxiliary coil 7 magnetizes the second and fourth yokes 4-2 and 4-4, and the auxiliary magnetic field is induced between the second and fourth yokes 4-2 and 4-4. Note that the auxiliary coil 7 is omitted from FIG. 3.

The magnetic head 1 can be manufactured by laminating magnetic thin films and performing patterning on the films to obtain the yokes and then laminating such yokes.

A method of recording data on the magnetic disk 20 by using the magnetic head 1 will be described below.

FIGS. 4A and 4B are schematic diagrams for explaining a recording method according to the first embodiment. FIGS. 4A and 4B depict a condition where horizontal recording is performed on the magnetic recording layer 24 of the magnetic disk 20. FIG. 4A schematically depicts the cross section taken along a plane orthogonal to the surface of the magnetic disk 20 near the magnetic head 1. FIG. 4B is a graph of coercivity distribution of the magnetic recording layer 24 in the x direction and intensity distribution of the recording magnetic field in the x direction. The reference symbol “A” denotes the position of the second tip magnetic pole 5-2 on the x-axis.

As depicted in FIG. 4A, the magnetic disk 20 according to the first embodiment includes a soft magnetic layer 22, a non-magnetic layer 23, and the magnetic recording layer 24 laminated from lowest to highest in this order on a non-magnetic disk substrate 21. Although not depicted in FIG. 4A, a protecting film and a lubricating layer are further laminated on the magnetic recording layer 24.

The magnetic recording layer 24 includes a layer that includes an Ising ferromagnetic material, such as UIr (uranium-iridium based compound). The easy axis of the magnetic recording layer 24 is preferably oriented in a horizontal direction (in the x-y plane). The non-magnetic layer 23 magnetically separates the soft magnetic layer 22 from the magnetic recording layer 24. The soft magnetic layer 22 functions as a path of the auxiliary magnetic field 11.

The recording magnetic pole 2 includes the first and third yokes 4-1 and 4-3 that are magnetized by an electric current that flows through the recording coil 6 wound around the connector 4a. The first and third yokes 4-1 and 4-3 have, at their tips, the first and third tip magnetic poles 5-1 and 5-3 that are flat surfaces facing the magnetic recording layer 24 and arranged to have the clearance, i.e. the recording gap, therebetween.

When the signal current that flows through the recording coil 6 magnetizes the recording magnetic pole 2, the recording magnetic field 10 is induced in the recording gap between a pair of the magnetic poles (the first and third tip magnetic poles 5-1 and 5-3) on the tips of a pair of the yokes (the first and third yokes 4-1 and 4-3). The recording magnetic field 10 is parallel to the magnetic recording layer 24 (i.e., parallel to the x-axis which is the spinning direction of the magnetic disk 20).

The length of the recording gap is set such that the second yoke 4-2 of the auxiliary magnetic pole 3 is held in the recording gap. It is typical that the length is larger than an appropriate bit length L in a domain to be recorded. Accordingly, a magnetic field intensity Hw of the recording magnetic field 10 induced in the recording gap is distributed in the x direction as represented in FIG. 4B. The distribution of the magnetic field intensity Hw has a moderate peak that is broader than the appropriate bit length L.

The auxiliary magnetic pole 3 includes the second and fourth yokes 4-2 and 4-4 that are magnetized by an electric current that flows through the auxiliary coil 7 wound around the connector 4b. The second and fourth yokes 4-2 and 4-4 have, at their tips, the second and fourth tip magnetic poles 5-2 and 5-4 that are the flat surfaces facing the magnetic recording layer 24. The clearance between the second and fourth yokes 4-2 and 4-4 is an auxiliary gap in which the auxiliary magnetic field 11 is to be induced.

When an auxiliary current, such as a pulse current or a steady-state current, that flows through the auxiliary coil 7 magnetizes the auxiliary magnetic pole 3, the auxiliary magnetic field 11 is induced in the clearance (the auxiliary gap) between the second and fourth tip magnetic poles 5-2 and 5-4. The auxiliary gap is set such that the second and fourth tip magnetic poles 5-2 and 5-4 are separated from each other by a distance larger than the depth of the soft magnetic layer 22. With this arrangement, a magnetic flux of the auxiliary magnetic field 11 flows from the second tip magnetic pole 5-2 to the fourth tip magnetic pole 5-4 as follows. The magnetic flux out of the second tip magnetic pole 5-2 vertically passes through the magnetic recording layer 24 to enter the soft magnetic layer 22. The magnetic flux propagates in the horizontal direction through the soft magnetic layer 22, and then returns to the fourth tip magnetic pole 5-4. Accordingly, the auxiliary magnetic field 11 perpendicular to the surface of the magnetic recording layer is applied to the magnetic recording layer 24 positioned just below the second tip magnetic pole 5-2.

The thickness (width in the x direction) of the second tip magnetic pole 5-2 is determined according to the thickness of the magnetic thin film, and thus it is easy to form the second tip magnetic pole 5-2 thin. When the second tip magnetic pole 5-2 is formed thin in this manner, the distribution of magnetic intensity in the x direction of the auxiliary magnetic field 11 that passes through the magnetic recording layer 24 has a narrow peak at a position just below the second tip magnetic pole 5-2.

In the first embodiment, each of magnetization directions 25 in the domains (magnetic domains) of the magnetic recording layer 24 agrees with a positive or negative direction of the x-axis, along which the recording magnetic field 10 is applied. The auxiliary magnetic field 11 perpendicular to the magnetization direction 25 (perpendicular to the z-axis) is applied to the domain positioned just below the second tip magnetic pole 5-2. As described previously, presence of such a magnetic field component perpendicular to the magnetization directions 25 decreases the Curie temperature of an Ising ferromagnet. Accordingly, the coercivity Hc of the Ising ferromagnet decreases according to the intensity of the magnetic filed component perpendicular to the magnetization directions 25 irrespective of the presence or absence of a change in temperature.

As described previously, the magnetic field intensity of the auxiliary magnetic field 11 is high in the narrow area directly below the second tip magnetic pole 5-2. In this case, a downward peak area where the coercivity Hc sharply decreases is produced within the narrow area just below the second tip magnetic pole 5-2 as indicated by the distribution of the coercivity Hc of the magnetic recording layer 24 in FIG. 4B. Because the width of the downward peak area on the distribution of the coercivity Hc is approximately as quite small as the thickness of the second tip magnetic pole 5-2, it is easy to set the width to a bit length employed in typical vertical recording.

Referring to FIGS. 4A and 4B, when the recording magnetic field 10 is applied along the x direction to the magnetic recording layer 24 whose distribution of the coercivity has the downward peak area where the coercivity Hc sharply decreases, the magnetization directions 25 are controlled by the recording magnetic field 10 in an area (area indicated as the bit length L in FIG. 4B) where the magnetic field intensity Hw of the recording magnetic field 10 exceeds the coercivity Hc. In this case, magnetic recording (writing) is performed on this area according to the recording magnetic field 10.

In the horizontal recording according to the first embodiment, magnetic recording is performed by applying the auxiliary magnetic field 11 so as to locally decrease the coercivity Hc of the magnetic recording layer 24, thereby eliminating the need of heating and cooling the magnetic recording layer 24 during magnetic recording. Accordingly, even in an inadequate environment in terms of heat dissipation, data can be magnetically recorded on the high-coercivity magnetic recording layer 24 by using a small recording magnetic field.

As with a typical recording magnetic field that is induced to perform vertical recording, the auxiliary magnetic field 11 is concentrated to the narrow area just below the second tip magnetic pole 5-2. Accordingly, the distribution of the coercivity Hc of the magnetic recording layer 24 has a downward peak where the coercivity decreases sharply in the narrow area. Accordingly, even when the recording magnetic field 10 has a broad peak, the area where magnetic recording is performed is approximately determined depending on the width of the downward narrow peak where the coercivity Hc sharply decreases on the distribution. This makes it possible to reduce the bit length L pertaining to recording, which leads to high-density recording.

In the first embodiment, the magnetic field intensity of the auxiliary magnetic field 11 is desirably adjusted according to an ambient temperature. More specifically, the coercivity Hc of the magnetic recording layer 24 represented in FIG. 4B depends not only on the magnetic field intensity of the auxiliary magnetic field 11 but also on the ambient temperature. Accordingly, by changing the intensity of the auxiliary magnetic field 11 according to the ambient temperature such that, for example, the higher the ambient temperature, the lower the intensity becomes, it is possible to cause the coercivity Hc to have a predetermined distribution independent of the ambient temperature. By keeping the magnetic field intensity of the recording magnetic field 10 to the predetermined distribution in this manner, magnetic recording can be performed by using the predetermined bit length L without fail.

According to the embodiment, in addition to a recording magnetic field, an auxiliary magnetic field that intersects, e.g., perpendicularly, with the recording magnetic field is applied to a magnetic recording layer that has Ising ferromagnetism. The Curie temperature of an Ising ferromagnet decreases with presence of a magnetic field component perpendicular to an easy axis of the Ising ferromagnet. Accordingly, the coercivity of the Ising ferromagnet decreases at the area where the auxiliary magnetic field is applied. This makes it possible to magnetically record data by using a relatively weak recording magnetic field without changing the temperature of the recording magnetic layer.

A second embodiment of the present invention relates to a magnetic disk device that performs perpendicular recording while applying the auxiliary magnetic field 11 parallel to the magnetic recording layer 24 to the magnetic recording layer 24.

The overall configuration of the magnetic disk device according to the second embodiment is similar to the magnetic disk device 101 according to the first embodiment depicted in FIG. 1. The magnetic disk device according to the second embodiment differs from the magnetic disk device 101 only in the magnetic recording layer 24 and the magnetic head 1. Hence, for simplifying the description, the magnetic recording layer 24 and the magnetic head 1 according to the second embodiment will be described in detail.

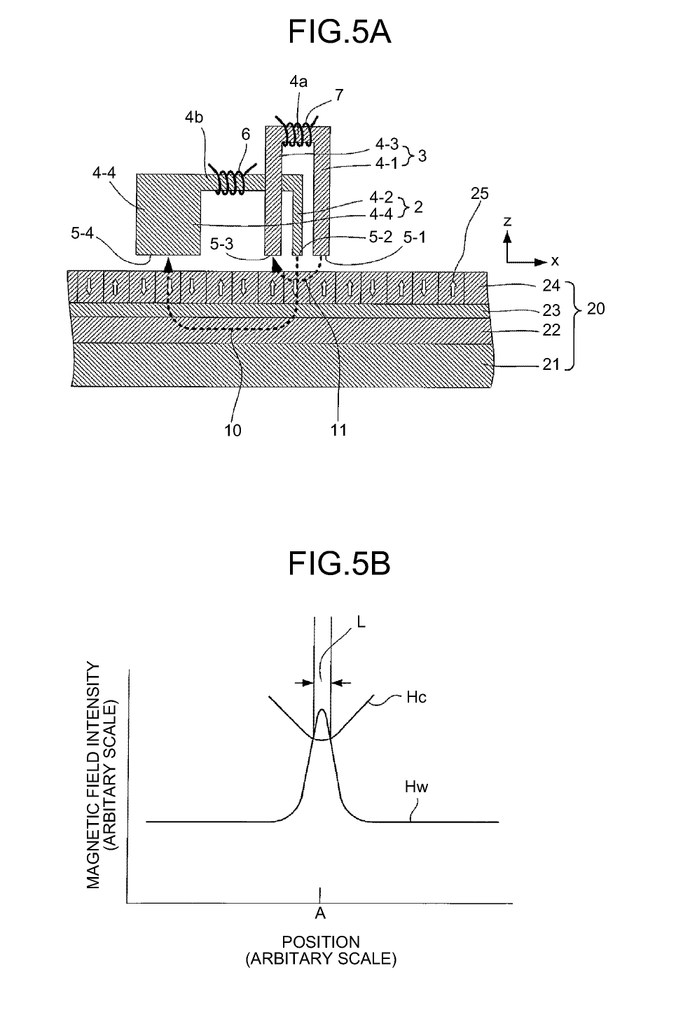

FIGS. 5A and 5B are schematic diagrams for explaining a recording method according to the second embodiment, depicting a state where vertical recording is performed on the magnetic recording layer 24 of the magnetic disk 20. FIG. 5A is a schematic cross-sectional view depicting a portion of the magnetic head 1 and its surroundings taken along a plane orthogonal to the surface of the magnetic disk 20. FIG. 5B is a graph of coercivity distribution of the magnetic recording layer 24 in the x direction and intensity distribution of the recording magnetic field 10 in the x direction.

As depicted in FIG. 5B, the magnetic disk 20 according to the second embodiment differs from the magnetic disk 20 according to the first embodiment only in using, as the magnetic recording layer 24, an Ising ferromagnet, e.g. UIr, whose easy axis is oriented in a vertical direction.

The magnetic head 1 of the second embodiment is constructed by replacing the recording magnetic pole 2 and the auxiliary magnetic pole 3 of the magnetic head 1 of the first embodiment to each other. More specifically, the first and third yokes 4-1 and 4-3 (the recording magnetic pole 2 of the first embodiment) that are magnetically connected by the connector 4a are used as the auxiliary magnetic pole 3 while the second and fourth yokes 4-2 and 4-4 (the auxiliary magnetic pole 3 of the first embodiment) that are magnetically connected by the connector 4b are used as the recording magnetic pole 2. The auxiliary coil 7 is wound around the connector 4a, and the recording coil 6 is wound around the connector 4b. These magnetic poles 2 and 3 have the similar shapes as those of the first embodiment depicted in FIGS. 2 and 3. The recording magnetic pole 2 is preferably smaller than the auxiliary magnetic pole 3 so that the inductance of the recording coil 6 is decreased to permit high-speed magnetic recording.

When a pulse current or a direct current that flows through the auxiliary coil 7 magnetizes the auxiliary magnetic pole 3, the auxiliary magnetic field 11 parallel to the magnetic recording layer 24 is induced in the clearance (the auxiliary gap) between the first and third tip magnetic poles 5-1 and 5-3. Because the auxiliary magnetic field 11 is perpendicular to the easy axis that is perpendicular to the magnetic recording layer 24, the coercivity Hc of the Ising ferromagnet that forms the magnetic recording layer 24 decreases with the presence of the auxiliary magnetic field 11. As described in the first embodiment, the clearance (auxiliary gap) between the first and third tip magnetic poles 5-1 and 5-3 is longer than the appropriate bit length L. Accordingly, the distribution of the coercivity Hc of the magnetic recording layer 24 has a downward peak that is broader than the bit length L as represented in FIG. 5B.

When a signal current that flows through the recording coil 6 magnetizes the second and fourth yokes 4-2 and 4-4 of the recording magnetic pole 2, the recording magnetic field 10 is induced between the second and fourth tip magnetic poles 5-2 and 5-4 according to the signal current. As described in the first embodiment, the recording magnetic field 10 induced between the second and fourth tip magnetic poles 5-2 and 5-4 forms a magnetic circuit as follows. The magnetic flux of the recording magnetic field 10 vertically passes through the magnetic recording layer 24 from the second tip magnetic pole 5-2, horizontally passes through the soft magnetic layer 22 which is a return path, and then returns to the fourth tip magnetic pole 5-4. Because the second tip magnetic pole 5-2 is thin (in the thickness in the x direction) as described previously, as represented in FIG. 5B, the distribution of the magnetic field intensity Hw of the recording magnetic field 10 in the x direction that vertically passes through the magnetic recording layer 24 from the second tip magnetic pole 5-2 has the very narrow peak just below the second tip magnetic pole 5-2.

Data recording on the magnetic recording layer 24 is performed in an area (the area indicated by the bit length L) where the magnetic field intensity Hw of the recording magnetic field 10 exceeds the coercivity Hc. The coercivity Hc decreases gently, centered near the area just below the second tip magnetic pole 5-2, which forms a downward gentle peak on the distribution. In contrast, the magnetic field intensity Hw of the recording magnetic field 10 has a sharp peak just below the second tip magnetic pole 5-2. Accordingly, in the second embodiment, the width of the recording area, i.e. the bit length L, mainly depends on the width of the peak of the magnetic field intensity Hw of the recording magnetic field 10. Because the peak width of the magnetic field intensity Hw of the recording magnetic field 10 is approximately the same as the thickness of the second tip magnetic pole 5-2, that is the film thickness of the second yoke 4-2, as described previously, it is easy to set the bit length L as short as a bit length employed in typical perpendicular recording.

According to the second embodiment, vertical recording can be performed without increase in temperature of the magnetic recording layer 24. Hence, the magnetic disk device according to the second embodiment for use in vertical recording can be used even in an inadequate environment in terms of heat dissipation.

A magnetic disk device according to a third embodiment of the present invention relates to a magnetic disk device that includes a single-pole type magnetic head in place of the magnetic head 1 of the first or second embodiment.

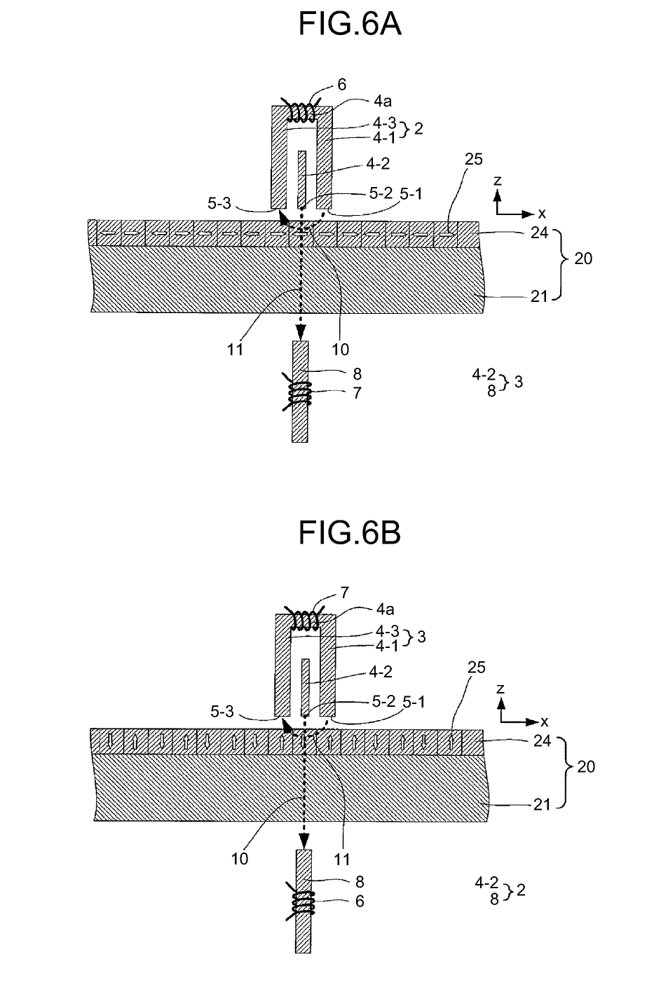

FIGS. 6A and 6B are schematic cross-sectional views for explaining a recording method according to the third embodiment. FIG. 6A is a schematic cross-sectional view of a portion of a magnetic head for use in horizontal recording according to the third embodiment and its surroundings. FIG. 6B a schematic cross-sectional view of a portion of a magnetic head for use in vertical recording according to the third embodiment and its surroundings.

As depicted in FIGS. 6A and 6B, the magnetic disk 20 of the third embodiment includes the magnetic recording layer 24 on the non-magnetic disk substrate 21. The magnetic recording layer 24 of the third embodiment is a single layer that exhibits Ising ferromagnetism. For the horizontal recording, the magnetic recording layer 24 is formed such that the easy axis is oriented in an in-plane direction of the magnetic recording layer 24 as depicted in FIG. 6A. For the vertical recording, the magnetic recording layer 24 is formed such that the easy axis is oriented perpendicular to the magnetic recording layer 24 as depicted in FIG. 6B.

The horizontal recording according to the third embodiment will be described below.

Referring to FIG. 6A, the recording magnetic pole 2 of the third embodiment for use in the horizontal recording is similar to the recording magnetic pole 2 of the first embodiment depicted in FIG. 2. The recording magnetic pole 2 includes the first and third yokes 4-1 and 4-3 that are to be magnetized by an electric current that flows through the recording coil 6 wound around the connector 4a. The first and third tip magnetic poles 5-1 and 5-3 on the tips of the first and third yokes 4-1 and 4-3 induce the recording magnetic field 10 parallel to the magnetic recording layer 24. In this manner, the recording magnetic pole 2 of the third embodiment is similar to that of the first embodiment not only in structure but also in function of generating the recording magnetic field 10 in the horizontal direction of the magnetic recording layer 24.

In contrast, the auxiliary magnetic pole 3 for use in the horizontal recording has the so-called single pole structure. More specifically, the second yoke 4-2, corresponding to a first magnetic pole, is arranged between the first yoke 4-1 and the third yoke 4-3 that form the recording magnetic pole 2. A magnetic bar 8, corresponding to a second magnetic pole, is arranged below the magnetic disk 20 at a position just below the second tip magnetic pole 5-2 that is formed on the tip of the second yoke 4-2. The magnetic bar 8 is a vertically oriented bar-like magnetic member around which the auxiliary coil 7 is wound.

When an auxiliary current that flows through the auxiliary coil 7 magnetizes the magnetic bar 8, the auxiliary magnetic field 11 is induced. The auxiliary magnetic field 11 radiated from the second yoke 4-2, which is located above the tip of the magnetic bar 8, passes through vertically the magnetic disk 20 to the magnetic bar 8. Because the auxiliary magnetic field 11 is perpendicular to the easy axis of the magnetic recording layer 24, the coercivity of the Ising ferromagnet, i.e., the coercivity of the magnetic recording layer 24, is locally decreased.

In the horizontal recording according to the third embodiment, the recording magnetic pole 2 applies the recording magnetic field 10 to the magnetic recording layer 24 along the horizontal direction of the magnetic recording layer 24 as in the first embodiment, while the auxiliary magnetic field 11 perpendicular to the magnetic recording layer 24 is applied to the magnetic recording layer 24. This results in a decrease in coercivity of the magnetic recording layer 24. Magnetic recording is performed on an area where the coercivity is lower than the magnetic field intensity of the recording magnetic field 10.

Because the distribution of the intensity of the auxiliary magnetic field 11 has a narrow peak, the area where the coercivity decreases is limited to a narrow area corresponding to the peak of the auxiliary magnetic field 11. Accordingly, as in the first embodiment, a bit length pertaining to recording mainly depends on the peak width rather than on the distribution of the intensity of the recording magnetic field 10. This makes it easy to use a relatively short bit length in magnetic recording.

The vertical recording according to the third embodiment will be described.

As depicted in FIG. 6B, in the vertical recording, the recording magnetic pole (the recording magnetic pole 2 depicted in FIG. 6A) for use in the horizontal recording according to the third embodiment is used as the auxiliary magnetic pole 3 while the auxiliary magnetic pole (the auxiliary magnetic pole 3 depicted in FIG. 6B) for use in the horizontal recording according to the third embodiment is used as the recording magnetic pole 2.

More specifically, the auxiliary coil 7 is wound around the connector 4a. An electric current that flows through the auxiliary coil 7 induces the auxiliary magnetic field 11 that is parallel to the magnetic recording layer 24 in the clearance (auxiliary gap) between the first and third tip magnetic poles 5-1 and 5-3 on the first and third yokes 4-1 and 4-3. Because the auxiliary magnetic field 11 is perpendicular to the easy axis that is perpendicular to the magnetic recording layer 24, the coercivity of the magnetic recording layer 24 is decreased.

The recording coil 6 is wound around the magnetic bar 8 that is arranged below the magnetic disk 20. An electric current that flows through the recording coil 6 magnetizes the magnetic bar 8. The recording magnetic field 10 is induced between the magnetized magnetic bar 8 and the second yoke 4-2 positioned just above the magnetic bar 8. The recording magnetic field 10 vertically passes through the magnetic disk 20.

Magnetic recording on the magnetic recording layer 24 is performed in an area where the coercivity is lower than the magnetic field intensity of the recording magnetic field 10. In this vertical recording, the auxiliary magnetic field 11 reduces the coercivity gently over an area broader than the bit length. However, the distribution of the intensity of the recording magnetic field 10 that is perpendicular to the magnetic recording layer 24 has a narrow peak. Accordingly, the area where magnetic recording is performed is determined depending on the narrow recording magnetic field 10. This makes it possible to use a relatively short bit length in magnetic recording as in the horizontal recording of the third embodiment.

A fourth embodiment of the present invention relates to a magnetic disk device that performs magnetic recording while applying an auxiliary magnetic field to the magnetic recording layer 24 in a width direction of the tracks.

The magnetic disk device according to the fourth embodiment differs from the magnetic disk device 101 according to the first embodiment having been previously described with reference to FIG. 1 only in the magnetic disk 20 and the magnetic head 1.

The magnetic disk 20 according to the fourth embodiment is similar to the magnetic disk 20 according to the third embodiment having been described with reference to FIG. 6A. More specifically, the magnetic disk 20 according to the fourth embodiment includes the magnetic recording layer 24 on the upper surface of the non-magnetic disk substrate 21. The magnetic recording layer 24 is a single layer that includes an Ising ferromagnet.

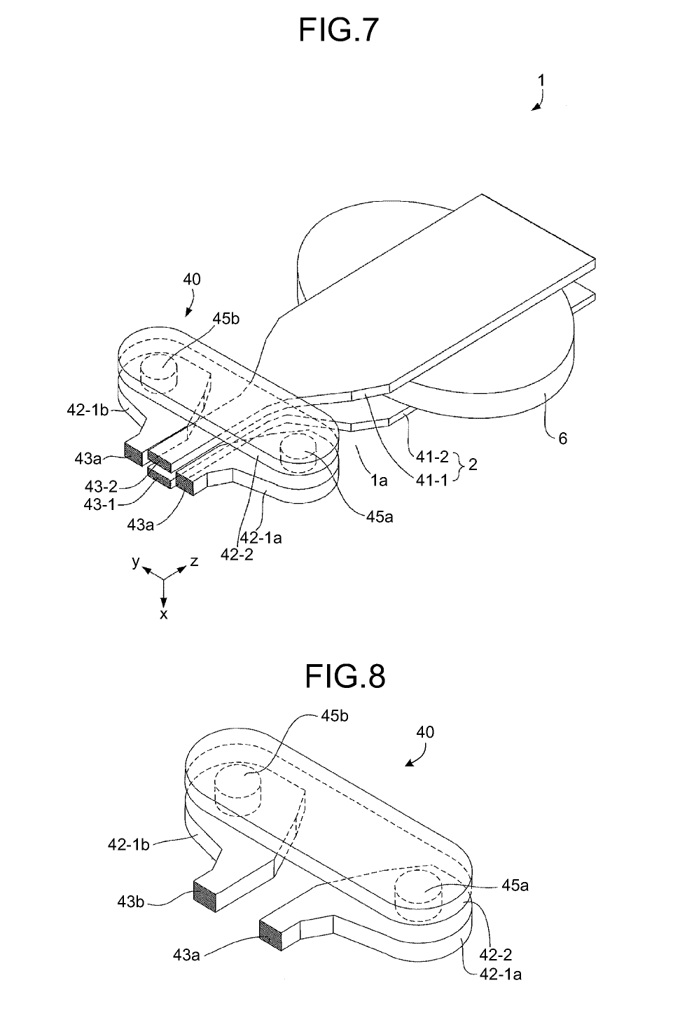

FIG. 7 is a schematic perspective view of the magnetic head 1 according to the fourth embodiment, depicting a main structure of a recording head of the magnetic head 1. FIG. 8 is a schematic perspective view of an auxiliary magnetic pole 40 according to the fourth embodiment, depicting a structure of the auxiliary magnetic pole 40 that is a component of the magnetic head 1. For simplification, an auxiliary coil wound around a connector 45a and an auxiliary coil wound around a connector 45b are omitted from FIGS. 7 and 8.

As depicted in FIGS. 7 and 8, the magnetic head 1 according to the fourth embodiment includes the recording magnetic pole 2 and the auxiliary magnetic pole 40.

The recording magnetic pole 2 has a similar structure with that of a thin film head for use in typical horizontal recording. The recording magnetic pole 2 includes a lower layer yoke 41-1 and an upper layer yoke 41-2 that are magnetic thin films to be magnetized by an electric current that flows through the recording coil 6. The tips of the lower layer yoke 41-1 and the upper layer yoke 41-2 are approximately as narrow as the track width. A flat tip magnetic poles 43-1 and 43-2, which form a pair, are formed on the tips of lower layer yoke 41-1 and the upper layer yoke 41-2, respectively. In the recording magnetic pole 2, as in a typical recording magnetic pole, a clearance (recording gap) between the tip magnetic poles 43-1 and 43-2 determines a bit length pertaining to recording.

The auxiliary magnetic pole 40 includes a pair of auxiliary magnetic yokes 42-1a and 42-1b arranged on both sides of the tip magnetic poles 43-1 and 43-2 in the y direction. Put another way, the auxiliary magnetic yokes 42-1a and 42-1b are arranged on opposite sides of the track. Tip auxiliary magnetic poles 43a and 43b are formed on the tips of the auxiliary magnetic yokes 42-1a and 42-1b, respectively. The tip auxiliary magnetic poles 43a and 43b are arranged such that the tip magnetic poles 43-1 and 43-2 are interposed between the tip auxiliary magnetic poles 43a and 43b in the track width direction. The tip auxiliary magnetic poles 43a and 43b are made flush with the tip magnetic poles 43-1 and 43-2.

The connectors 45a and 45b that are columnar magnetic members are arranged upright on rear ends (ends in the z direction) of the auxiliary magnetic yokes 42-1a and 42-1b. A connecting yoke 42-2 formed of a magnetic thin film magnetically bridges the connectors 45a and 45b over the lower and upper layer yokes 41-1 and 41-2.

An auxiliary coil is wound around each of the connectors 45a and 45b that magnetically connects the auxiliary magnetic yokes 42-1a and 42-1b together. An auxiliary current that flows through the auxiliary coils induces an auxiliary magnetic field in the clearance between the tip auxiliary magnetic poles 43a and 43b. The auxiliary magnetic field is parallel to the magnetic recording layer 24 that is oriented in the track width direction.

The auxiliary magnetic field is perpendicular to a recording magnetic field (in the x direction) that is induced between the tip magnetic poles 43-1 and 43-2 of the recording magnetic pole 2. Accordingly, the coercivity of the magnetic recording layer 24 that includes the Ising ferromagnet is decreased by the auxiliary magnetic field. Hence, magnetic recording is performed in an area where the coercivity is lower than the magnetic field intensity of the recording magnetic field.

In this manner, the area where the coercivity is decreased without increase in temperature is formed also in the fourth embodiment. Magnetic recording is performed by utilizing the area. This makes it possible to write data in the high-coercivity magnetic recording layer 24 even in an inadequate environment in terms of heat dissipation.

According to the fourth embodiment, the auxiliary magnetic field is produced by the tip auxiliary magnetic poles 43a and 43b that are arranged on the opposite sides of the track in the track width direction. Accordingly, the intensity of the auxiliary magnetic field is distributed relatively broad. In contrast, the clearance (recording gap) between the tip magnetic poles 43-1 and 43-2 that induce the recording magnetic field is determined by a single non-magnetic layer that is interposed between the lower and upper layer yokes 41-1 and 41-2. This makes it easy to make the recording gap sufficiently narrow. Hence, it is possible to use a short bit length in magnetic recording, which leads to high-density recording.

A fifth embodiment relates to a magnetic disk device for use in horizontal recording in which an auxiliary magnetic field is applied to the magnetic recording layer 24 from a circumferentially outer side of the magnetic disk 20 to perform the magnetic recording.

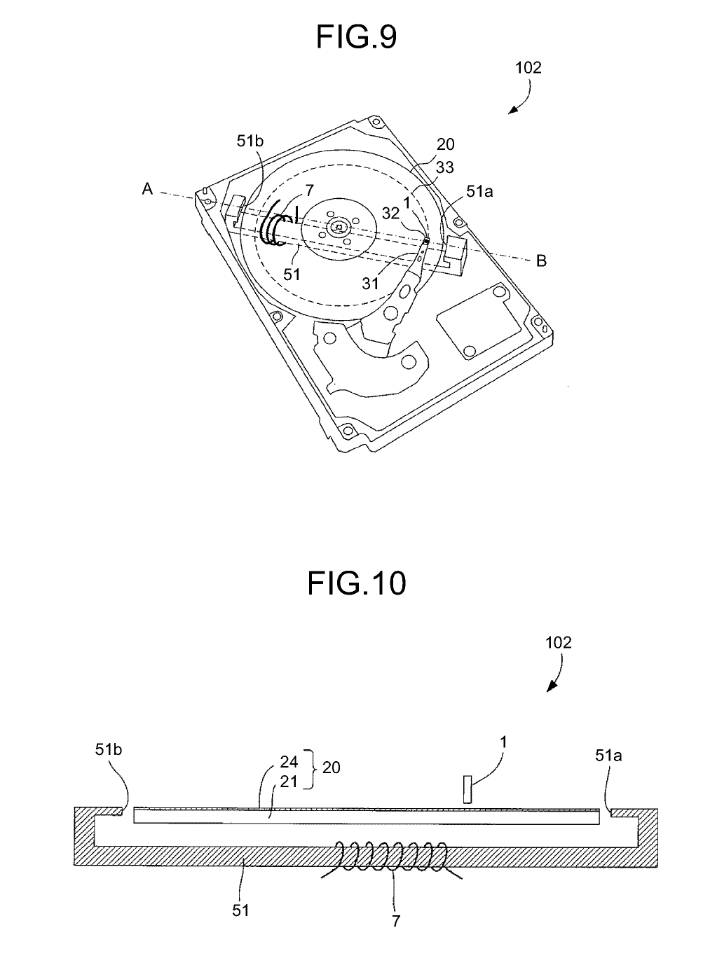

FIG. 9 is a schematic perspective view depicting an overall configuration of a magnetic disk device 102 according to the fifth embodiment. FIG. 10 is a schematic cross-sectional view of the magnetic disk device 102 according to the fifth embodiment taken along a line A-B that extends orthogonal to the track 33 depicted in FIG. 9.

Referring to FIGS. 9 and 10, the magnetic disk device 102 according to the fifth embodiment is similar to a typical magnetic disk device, including the magnetic head 1, for use in typical horizontal recording, except that the magnetic recording layer 24 exhibits Ising ferromagnetism and the magnetic disk device 102 additionally includes an auxiliary magnetic pole 51.

The magnetic head 1 includes, as a recording head, a thin-film recording head for use in typical horizontal recording. The magnetic disk 20 includes the magnetic recording layer 24 that exhibits Ising ferromagnetism on the non-magnetic disk substrate 21. Accordingly, magnetic recording is performed by defining a bit length along the tangential direction of the track 33, that is, in the direction orthogonal to the plane of FIG. 10.

The auxiliary magnetic pole 51 is a soft magnetic bar-like member that is arranged below the magnetic disk 20. The auxiliary magnetic pole 51 extends substantially along the diameter of the magnetic disk 20 across the magnetic disk 20 and has upwardly bent portions on opposite ends thereof. The upwardly bent portions include, on their surfaces, a pair of tip auxiliary magnetic poles 51a and 51b arranged near the outer circumferential surface of the magnetic disk 20 and facing each other while interposing the magnetic disk 20 therebetween.

When an electric current that flows through the auxiliary coil 7 magnetizes the auxiliary magnetic pole 51, an auxiliary magnetic field that is radiated laterally on the plane of FIG. 10 is induced between the tip auxiliary magnetic poles 51a and 51b. This auxiliary magnetic field is parallel with the magnetic recording layer 24 and perpendicular to the direction of the bit length (perpendicular to the plane of FIG. 10). The coercivity of the magnetic recording layer 24 exhibiting Ising ferromagnetism is decreased at an area between the tip auxiliary magnetic poles 51a and 51b with presence of the auxiliary magnetic field that is perpendicular to the direction of the bit length. The magnetic head 1 is positioned above the area where the coercivity is decreased and performs magnetic recording by applying the recording magnetic field to the magnetic recording layer 24 at the area where the coercivity is decreased.

In this manner, magnetic recording on the high-coercivity magnetic recording layer 24 can be performed without increase in temperature also in the fifth embodiment. This makes it possible to perform magnetic recording by using a general magnetic head even in an inadequate environment in terms of heat dissipation.

A modification of the fifth embodiment of the present invention relates to a magnetic disk device for use in vertical recording. The vertical recording is a method of performing magnetic recording by applying an auxiliary magnetic field to the magnetic recording layer 24 from a circumferentially outer side of the magnetic disk.

In the modification of the fifth embodiment, the easy axis of the magnetic recording layer 24 is oriented in the vertical (in a thickness direction of the magnetic film). The magnetic head 1 is a single-pole type magnetic head (e.g., the single-pole type magnetic head depicted in FIG. 6B) that includes the recording magnetic pole 2 that sandwiches the magnetic disk 20 from above and below. The magnetic disk device according to the modification of the fifth embodiment is similar with the magnetic disk device 102 of the fifth embodiment in other components.

In the modification of the fifth embodiment, an auxiliary magnetic field that is perpendicular to the easy axis, which is perpendicular to the magnetic recording layer 24, is applied to the magnetic recording layer 24. Accordingly, the coercivity of the magnetic recording layer 24 is decreased, and magnetic recording to the magnetic recording layer 24 is performed at the area just below the magnetic head 1 as in the fifth embodiment.

In this manner, a magnetic recording device according to the modification of the fifth embodiment performs magnetic recording on the high-coercivity magnetic recording layer 24 without heating the magnetic recording layer 24. Hence, the magnetic recording device can perform magnetic recording reliably even in an inadequate environment in terms of heat dissipation.

According to the present invention, magnetic recording on a high-coercivity magnetic recording layer of a magnetic disk device can be performed without a temperature rise by using a relatively weak recording magnetic field.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic disk device comprising:
a magnetic disk that includes a magnetic recording layer exhibiting Ising ferromagnetism;
a recording magnetic pole that includes a pair of tip magnetic poles that apply a recording magnetic field to an area of the magnetic recording layer; and
an auxiliary magnetic pole that includes a pair of tip magnetic poles that apply an auxiliary magnetic field that intersects with the recording magnetic field to the area where the recording magnetic field is applied, wherein the recording magnetic field is applied to the area while the auxiliary magnetic field is applied to the area.

2. The magnetic disk device according to claim 1, wherein
the recording magnetic field is applied along in-plane direction of the magnetic recording layer, and
the auxiliary magnetic field is applied along a direction perpendicular to the magnetic recording layer.

3. The magnetic disk device according to claim 1, wherein
the recording magnetic field is applied along a direction perpendicular to the magnetic recording layer, and
the auxiliary magnetic field is applied along in-plane direction of the magnetic recording layer.

4. The magnetic disk device according to claim 1, wherein
the pair of the tip magnetic poles of the auxiliary magnetic pole is arranged on outer side of an outer circumferential surface of the magnetic disk and on tangents of tracks to be recorded by the pair of the tip magnetic poles of the recording magnetic poles, so as to face each other while interposing the magnetic disk therebetween.

5. The magnetic disk device according to claim 1, wherein
the magnetic recording layer includes a uranium-iridium-based compound.

6. A magnetic head for use in recording data on a magnetic recording layer of a magnetic disk, the magnetic head comprising:
first to fourth yokes that are magnetic thin films, the yokes being laminated with non-magnetic layers interposed therebetween on an upper surface of a substrate;
first to fourth tip magnetic poles that are formed on tips of the first to fourth yokes, respectively, and arranged perpendicular to the upper surface of the substrate, the first yoke and the third yoke being magnetically connected together, the second yoke and the fourth yoke being magnetically connected together, the first tip magnetic pole and the third tip magnetic pole defining a recording gap therebetween;
a recording coil that magnetizes the first and third yokes to induce a recording magnetic field parallel to the magnetic recording layer in the recording gap; and
an auxiliary coil that magnetizes the second fourth yokes to induce an auxiliary magnetic field flowing from the second tip magnetic pole to the fourth tip magnetic pole such that a magnetic flux of the auxiliary magnetic field out of the second tip magnetic pole perpendicularly enters the magnetic recording layer and returns to the second tip magnetic pole through the fourth tip magnetic pole that serves as a return path.

7. A magnetic head for use in recording data on a magnetic recording layer of a magnetic disk, the magnetic head comprising:
first to fourth yokes that are magnetic thin films, the yokes being laminated with non-magnetic layers interposed therebetween on an upper surface of a substrate;
first to fourth tip magnetic poles that are formed on tips of the first to fourth yokes, respectively, and arranged perpendicular to the upper surface of the substrate, the first yoke and the third yoke being magnetically connected together, the second yoke and the fourth yoke being magnetically connected together, the first tip magnetic pole and the third tip magnetic pole defining a recording gap therebetween;
an auxiliary coil that magnetizes the first and third yokes to induce an auxiliary magnetic field parallel to the magnetic recording layer in the recording gap; and
a recording coil that magnetizes the second and fourth yokes to induce a recording magnetic field flowing from the second tip magnetic pole to the fourth tip magnetic pole such that a magnetic flux of the recording magnetic field out of the second tip magnetic pole perpendicularly enters the magnetic recording layer and returns to the second tip magnetic pole through the fourth tip magnetic pole that serves as a return path.

8. A magnetic head for use in recording data on a magnetic recording layer of a magnetic disk, the magnetic head comprising:
a pair of yokes that are magnetically connected together, each of the yokes being formed of a magnetic thin film and including a tip magnetic pole on a tip of the yoke, the tip magnetic poles of the yokes being arranged to have a recording gap therebetween;
a recording coil that magnetizes the pair of the yokes to induce a recording magnetic field parallel to the magnetic recording layer in the recording gap;
a pair of auxiliary yokes that are magnetically connected together, each of the auxiliary yokes being formed of a magnetic thin film and including a tip magnetic pole, the tip magnetic poles of the auxiliary yokes are arranged to sandwich the tip magnetic poles of the yokes therebetween in a width direction of a track; and
an auxiliary coil that magnetizes the auxiliary yokes to induce an auxiliary magnetic field parallel to the magnetic recording layer between the tip magnetic poles of the auxiliary magnetic pole.
